(19) United States
(12) Patent Application Publication
(10) Pub. No.: US 2017/0029053 A1
(43) Pub. Date: Feb. 2, 2017

(54) VEHICLE BODY ASSEMBLY SYSTEM AND VEHICLE BODY ASSEMBLY METHOD

(71) Applicant: HONDA MOTOR CO., LTD., Tokyo (JP)

(72) Inventors: Hisashi ISHITSUKA, Hagamachi (JP); Yoshiaki ASANO, Hagamachi (JP); Koichi TAKEUCHI, Hagamachi (JP)

(73) Assignee: HONDA MOTOR CO., LTD., Tokyo (JP)

(21) Appl. No.: 15/302,850

(22) PCT Filed: Apr. 9, 2015
(86) PCT No.: PCT/JP2015/061102

§ 371 Date: Oct. 7, 2016

(30) Foreign Application Priority Data
Apr. 9, 2014 (JP) 2014-080321

(51) Int. Cl. B62D 65/02; B23K 37/04

(52) U.S. Cl. CPC B62D 65/026; B62D 65/02; B23K 37/0426; B62D 65/022; B62D 25/2018

(57) ABSTRACT

Provided are a vehicle body assembly system and vehicle body assembly method with which it is possible to reduce equipment space and equipment costs to a greater extent than in the past. A vehicle body assembly system in which components formed from one or more parts constituting a vehicle body are welded together to assemble a vehicle body structure, wherein the vehicle body assembly system (1) is characterized in being provided with upper jigs (41, 51, 61) for fixing the one or more parts in a state in which the relative position and orientation thereof as a component can be maintained, a lower jig (81) connected to the component fixed by the upper jigs (41, 51, 61), and a welding robot (7), the upper jigs (41, 51, 61) and the lower jig (81) being provided, respectively, with upper-jig connecting parts (413, 513, 613) and lower-jig connecting parts (813) that are connected to each other, and the welding robot (7) welding together the one or more parts forming a component, and welding together the components, in a state in which the connections between the component and the lower jig (81), and the connections between the upper jigs (41, 51, 61) and the lower jig (81), are maintained.

### TECHNICAL FIELD

The present invention relates to a vehicle body assembly system and vehicle body assembly method.

### BACKGROUND ART

Conventionally, Patent Documents 1 and 2 have been disclosed as technology for assembling vehicle bodies by welding the constituent parts of a vehicle body, for example. These vehicle body assembly technologies are configured to include a main floor process, etc. for assembling the main floor, for example.

Patent Document 1: Japanese Unexamined Patent Application, Publication No. 2013-159125

Patent Document 2: Japanese Unexamined Patent Application, Publication No. 2000-61647

### DISCLOSURE OF THE INVENTION

### Problems to be Solved by the Invention

However, the main floor is configured from a front component, front floor component and rear floor component, and thus the technologies disclosed in the above-mentioned Patent Documents have required to provide a front component process, a front floor component process and a rear floor component process upstream of a main floor process, and to pre-weld each component. For this reason, a welding jig and a welding robot for welding the parts forming each component have been required in each of these upstream processes. In other words, a complete set of welding equipment dedicated for each of these upstream processes is required, and thus improvement has been demanded from the viewpoint of equipment space and equipment cost.

The present invention has been made taking into account the above, and an object thereof is to provide a vehicle body assembly method and vehicle body assembly system that can reduce the equipment space and equipment cost more than those conventionally.

### Means for Solving the Problems

In order to achieve the above-mentioned objects, the present invention provides a vehicle body assembly system (for example, the vehicle body assembly system 1 described later) for assembling a vehicle body structure (for example, the main floor described later) by forming a component (for example, the front component 10, front floor component 20, rear floor component 30 described later) from at least one part (for example, the front side frame 11, wheelhouse housing 12, bulkhead 13, dashboard 14, front floor, rear side frame 31, first cross-member 32, second cross-member 33 described later) constituting a vehicle body, and welding together components, the system including: an upper jig (for example, the upper jigs 41, 51, 61 described later) that fixes to mount the at least one part in a state that can maintain a relative position and posture as the component; a lower jig (for example, the lower jig 81 described later) that is connected to the component fixed to mount to the upper jig; and a welding device (for example, the welding robot 7 described later), in which the upper jig and the lower jig each include a connecting part (for example, the upper-jig connecting parts 413, 513, 613, and lower-jig connecting part 813 described later) to be connected to each other, and the welding device welds together the at least one part forming the component and welds together the components in a state maintaining a connection between the component and the lower jig, and a connection between the upper jig and the lower jig.

The vehicle body assembly system of the present invention provides an upper jig that fixes to mount the at least one part in a state that can maintain a relative position and posture as the component, and a lower jig that is connected to the component fixed to mount to the upper jig, as well as connecting with the upper jig. Then, at least one part forming a component and the components are welded together by the welding device in a state maintaining the connection of the lower jig with the components and the connection between the upper jigs and lower jig.

According to the vehicle body assembly system of the present invention, due to performing the welding of at least one part forming a component in parallel with welding together of components, a step for each component that had been assembled by welding in advance conventionally is unnecessary. Therefore, according to the present invention, it is possible to consolidate steps, and thus possible to reduce the equipment space and equipment cost.

In addition, in order to achieve the above-mentioned objects, the present invention provides a vehicle body assembly method of assembling a vehicle body structure by forming a component from at least one part constituting a vehicle body, and welding together the components, the method including the steps of: fixing to mount the at least one part to an upper jig in a state that can maintain a relative position and posture as the component; connecting the component fixed to mount to the upper jig in the step of fixing to a lower jig, and connecting the upper jig and the lower jig; and welding together the at least one part forming the component and welding together the components in a state maintaining a connection between the component and the lower jig, and a connection between the upper jig and the lower jig.

In addition, with the vehicle body assembly method of the present invention, first, at least one part is fixed to mount to the upper jig in a state that can maintain the relative position and posture as a component. Next, the component thus fixed to mount to the upper jig is connected to the lower jig, and the upper jig and lower jig are connected. Then, at least one part forming a component and the components are welded together while maintaining these connected states.

Similar effects as the above-mentioned invention of a vehicle body assembly system are exerted by the vehicle body assembly method of the present invention.

### Effects of the Invention

According to the present invention, it is possible to provide a vehicle body assembly method and vehicle body assembly system that can reduce the equipment space and equipment cost more than those conventionally.

### BRIEF DESCRIPTION OF THE DRAWINGS

FIG. 1 is a perspective view of a front component according to an embodiment of the present invention;

FIG. 2 is a perspective view showing a rear floor component according to the embodiment;

FIG. 3 is a view showing a state of a vehicle body assembly system according to the embodiment, when gripping the floor component by an upper jig;

FIG. 4 is a view showing a state of a vehicle body assembly system according to the embodiment, when conveying each component gripped by each upper jig; and

FIG. 5 is a view showing a state of a vehicle body assembly system according to the embodiment, when welding by way of welding robots.

### PREFERRED MODE FOR CARRYING OUT THE INVENTION

Hereinafter, embodiments of the present invention will be explained in detail by referencing the drawings.

A vehicle body assembly system 1 according to the present embodiment is a system for assembling the main floor of an automobile vehicle body. Herein, the main floor is configured from a front component, a front floor component, and a rear floor component.

The vehicle body assembly system 1 according to the present embodiment includes: a set station 2, a front-component conveying robot 4 as a front-component conveying device, a front-floor-component conveying robot 5 as a front-floor-component conveying device, a rear-floor-component conveying robot 6 as a rear-floor-component conveying device, welding robots 7 as welding devices, and an assembly station 8.

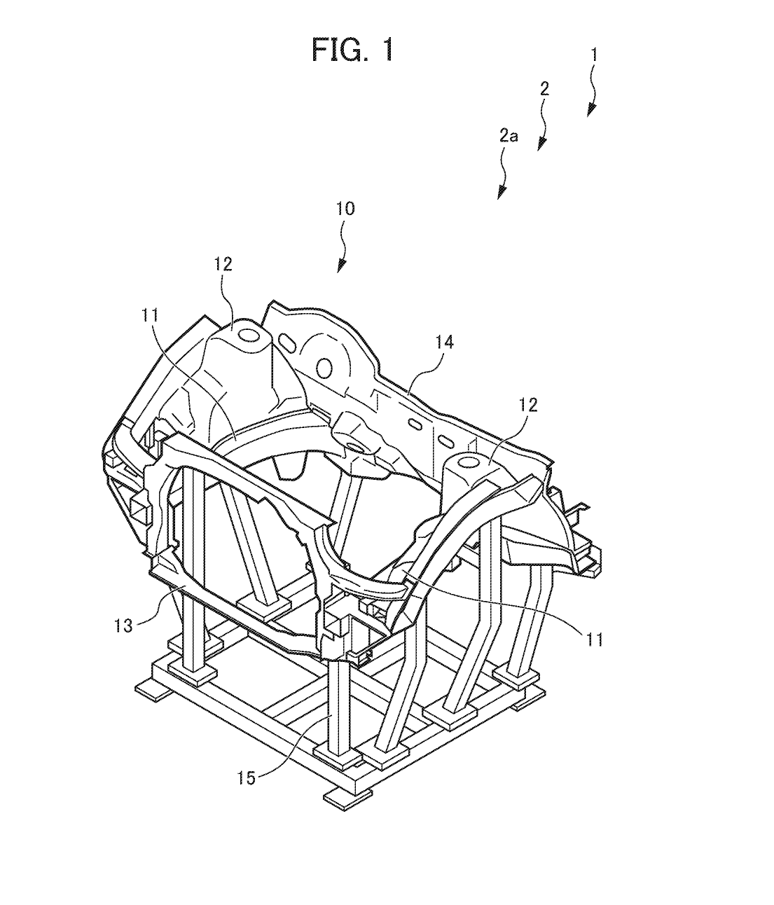

FIG. 1 is a perspective view showing a front component 10 according to the embodiment of the present invention.

The front component 10 is a rectangular frame shape, and is installed to a vehicle body forward side portion of the automobile. A space surrounded by this front component 10 configures an engine room in which the engine is accommodated.

As shown in FIG. 1, the front component 10 includes a pair of front-side frames 11, 11, a pair of wheelhouse housings 12, 12, a bulkhead 13 and a dashboard 14. In other words, the front component 10 is configured from six parts.

The pair of front-side frames 11, 11 is arranged laterally of the engine.

The pair of wheelhouse housings 12, 12 is arranged on the pair of front-side frames 11, 11, respectively.

The bulkhead 13 is arranged forward of the engine.

The dashboard 14 is arranged rearward the engine.

In addition, as shown in FIG. 1, at a front set station 2a possessed by the set station 2, the front component 10 is set on a front component set stand 15, in a state in which the aforementioned six parts reproduce the relative position and posture as the front component 10. In other words, the six parts set on this front component set stand 15 are in a state not welded together.

Herein, the front set station 2a included by the set station 2 of the present embodiment roughly sets the relative position and posture as the front component 10. In other words, the accuracy of the relative positions and postures of the aforementioned six parts set on the front component set stand 15 may be low. For this reason, the front component set stand 15 is configured by a simple support stand, and the form thereof is modified as appropriate according to the vehicle model.

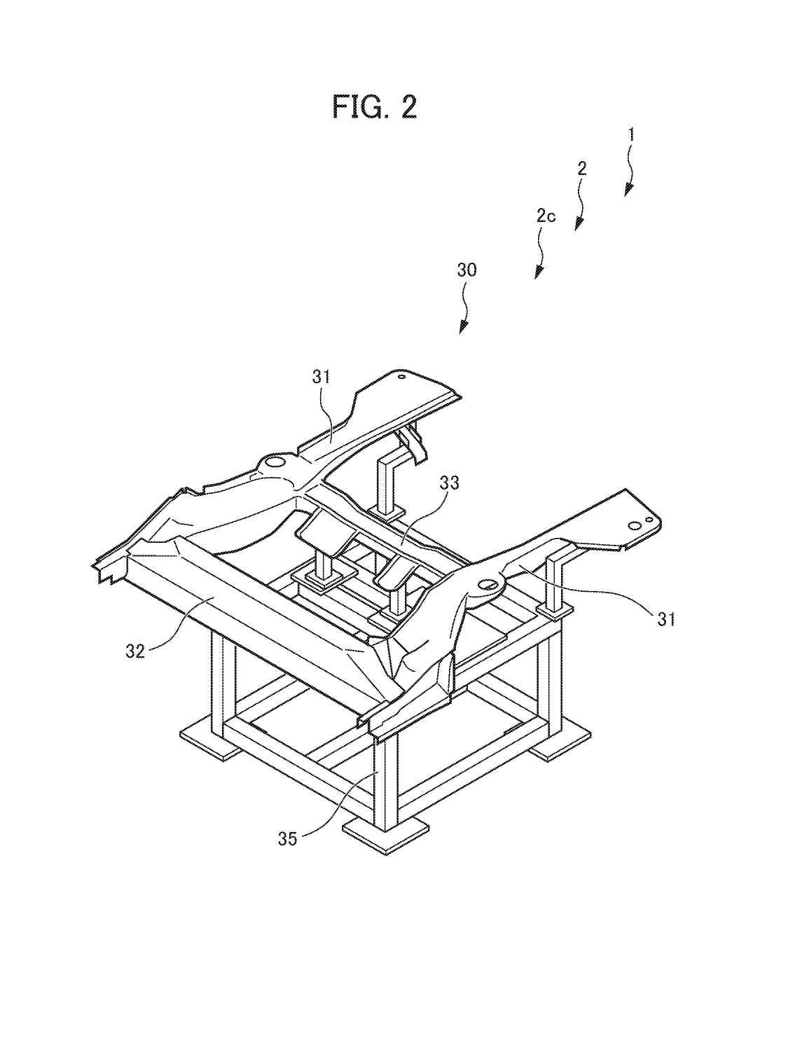

FIG. 2 is a perspective view of the rear floor component 30 according to the embodiment of the present invention.

The rear floor component 30 is installed to a vehicle body rear-side portion of the automobile. The space surrounded by this rear floor component 30 constitutes the rear floor.

As shown in FIG. 2, the rear floor component 30 includes a pair of rear-side frames 31, 31, a first cross-member 32 and a second cross-member 33. In other words, the rear floor component 30 is configured from four parts.

The pair of rear-side frames 31, 31 is arranged laterally to the rear floor.

The first cross-member 32 is arranged to bridge between the pair of rear-side frames 31, 31 at a more forward side of the vehicle body than the second cross-member 33.

The second cross-member 33 is arranged to bridge between the pair of rear-side frames 31, 31 at a more rearward side of the vehicle body than the first cross-member 32.

In addition, as shown in FIG. 2, the rear floor component 30 is set on the rear-floor-component set stand 35 in a state in which the aforementioned four parts reproduce the relative position and posture as the rear floor component 30, in the rear floor set station 2c possessed by the set station 2. In other words, the four parts set on this rear-floor-component set stand 35 are a state not welded together.

Herein, the rear floor set station 2c possessed by the set station 2 of the present embodiment roughly sets the relative position and posture as the rear floor component 30. In other words, the precision of the relative position and posture of the aforementioned four parts set on the rear-floor-component set stand 35 may be low. For this reason, the rear-floor-component set stand 35 is configured by a simple support stand, and the form thereof is changed as appropriate according to the vehicle model.

On the other hand, the front floor component 20 according to the present embodiment is configured from the one part of only the front floor 21. For this reason, it is unnecessary to set on the set stand of the set station 2 as for the front component 10 and rear floor component 30.

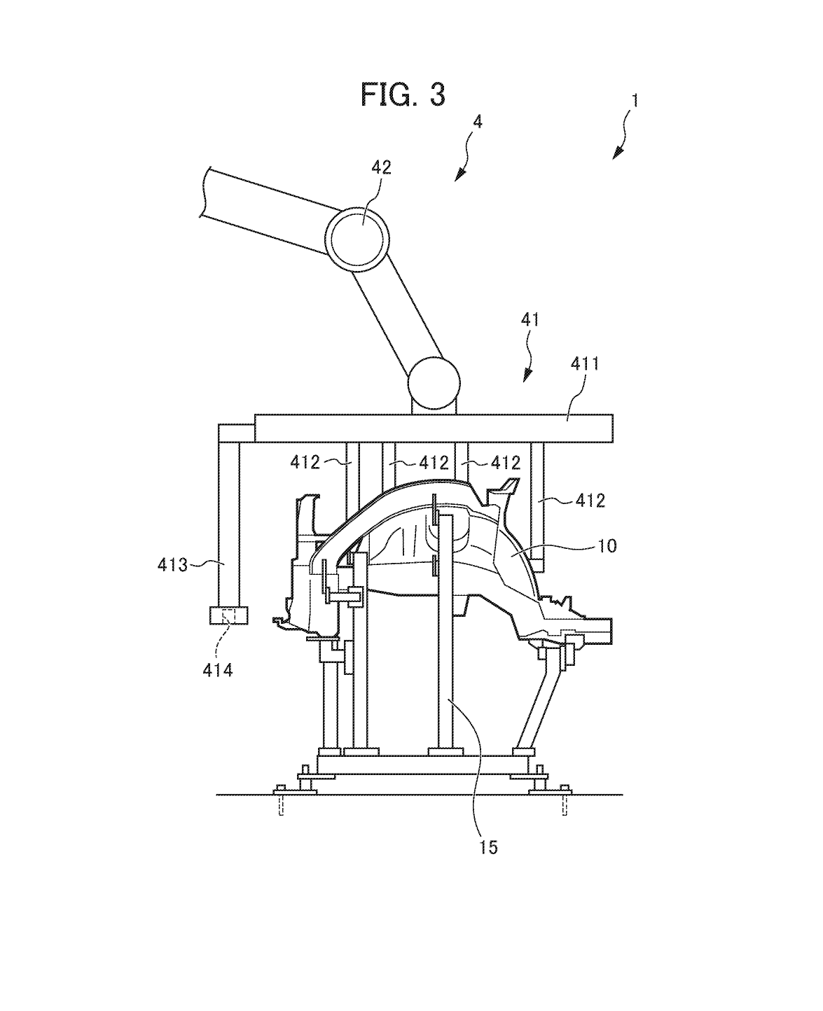

FIG. 3 is a view showing a state of the vehicle body assembly system 1 according to the present embodiment when gripping the front component 10 by the upper jig 41.

As shown in FIG. 3, the front component 10 set on the front component set stand 15 of the front set station 2a is gripped and conveyed by the front component conveying robot 4.

The front component conveying robot 4 includes the upper jig 41 that grips then fixes to mount the front component 10, and a multiaxial arm 42 that causes the position and posture in three-dimensional space of this upper jig 41 to change.

The upper jig 41 includes an upper-jig main body 411, a plurality of grippers 412, and an upper-jig connecting part 413.

It should be noted that, for this upper jig 41, the positions and lengths of the grippers 412 and upper-jig connecting part 413 are changed as appropriate according to the vehicle model.

The upper-jig main body 411 is a rectangular frame-shaped member installed to the leading end of the multiaxial arm 42. This upper-jig main body 411 is provided to extend so that each frame member is orthogonal relative to the extending direction of the arm on the leading-end side of the multiaxial arm 42.

The plurality of grippers 412 is extended from the upper-jig main body 411 to the leading-end side. This plurality of grippers 412 grips predetermined locations of the front component 10, respectively.

The upper-jig connecting part 413 is extended from an end of the upper-jig main body 411 to the leading-end side. This upper-jig connecting part 413 is connected to a lower-jig connecting part 813 possessed by a lower jig 81 of the assembly station 8 described later. In other words, a fitting hole 414 into which a rod 814 constituting a lower-jig connecting part 813 fits is formed in the upper-jig connecting part 413.

It should be noted that pairs of the upper-jig connecting part 413 and lower-jig connecting part 813 are provided in the left-right direction of the vehicle body, respectively.

Similarly, although omitted from illustration, the rear floor component 30 set on the rear-floor-component set stand 35 of the rear floor set station 2c is gripped and conveyed by the rear-floor-component conveying robot 6.

In addition, although omitted from illustration, the front floor component 20 is gripped and conveyed by the front-floor-component conveying robot 5.

It should be noted that the front-floor-component conveying robot 5 and the rear-floor-component conveying robot 6 are the same configurations as the front component conveying robot 4, except for the position and length of the grippers on the upper jigs differing.

In other words, the front-floor-component conveying robot 5 includes an upper jig 51 that grips and then fixes to mount the front floor component 20, and a multiaxial arm 52 that causes the position and posture in three-dimensional space of this upper jig 51 to change.

The front floor component conveying robot 6 includes an upper jig 61 that grips and fixes to mount the rear front component 30, and a multiaxial arm 62 that causes the position and posture in three-dimensional space of this upper jig 61 to change.

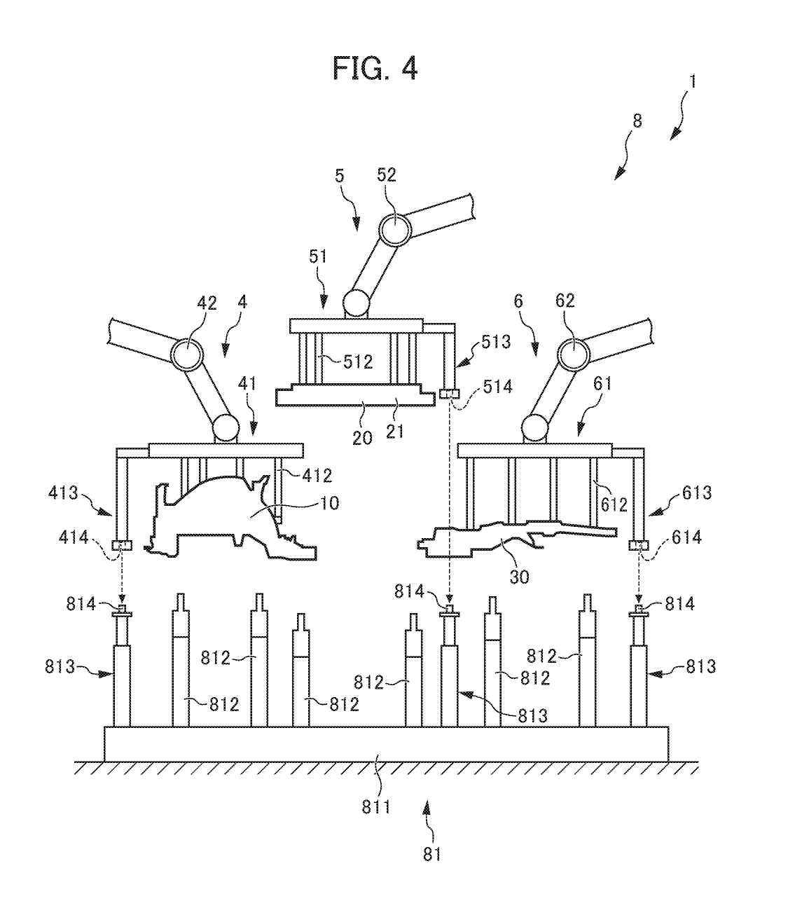

FIG. 4 is a view showing a state of the vehicle body assembly system 1 according to the present embodiment when conveying the each component gripped by the respective upper jigs.

As shown in FIG. 4, the front component conveying robot 4 grips the front component 10 and conveys to the assembly station 8. The front-floor-component conveying robot 5 grips the front floor component 20 and conveys to the assembly station 8. The rear-floor-component conveying robot 6 grips the rear floor component 30 and conveys to the assembly station 8.

More specifically, these conveying robots convey each component to the assembly station 8 so that the front component 10 is arranged at an end side thereof, the front floor component 20 is arranged at the center, and the rear front component 30 is arranged at the other end side.

Herein, as shown in FIG. 4, the assembly station 8 includes the lower jig 81.

The lower jig 81 includes a lower-jig main body 911, a plurality of positioning pins 812, and three lower-jig connecting parts 813.

The lower-jig main body 811 constitutes a base of the assembly station 8.

The plurality of positioning pins 812 is provided to be insertable into positioning holes formed in the bottom face of each component. This plurality of positioning pins 812 each includes a cylinder mechanism to make slidingly movable up and down. In addition, this plurality of positioning pins 812 is provided to be slidable in the horizontal direction, and becomes movable in the horizontal direction according to the vehicle model.

The three lower-jig connecting parts 813 include rods 814 at the leading end, respectively. Each of the rods 814 fits into the fitting holes 414, 514, 614 formed in the leading ends of the upper-jig connecting parts 413, 513, 613 of each conveying robot, respectively. These three lower-jig connecting parts 813 include cylinder mechanisms to make slidingly movable up and down, respectively. In addition, this plurality of positioning pins 812 is provided to be slidable in the horizontal direction, and becomes moveable in the horizontal direction according to the vehicle model.

Therefore, as shown in FIG. 4, each conveying robot conveys each component so that the fitting holes 414, 514, 614 of the upper-jig connecting parts 413, 513, 613 possessed by the respective upper jigs 41, 51, 61 fit with the respective rods 814 of the three lower-jig connecting parts 813.

In addition, each conveying robot conveys the respective components so that the positioning pins 812 of the lower jig 81 are guided to insert in the positioning holes of each component.

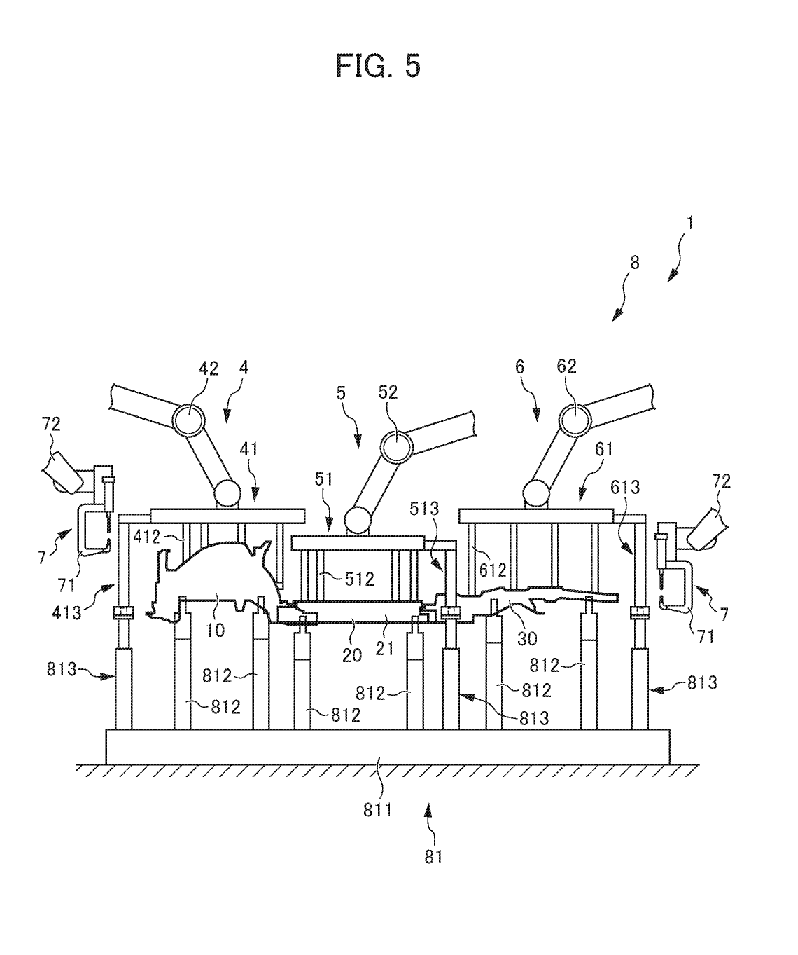

FIG. 5 is a view showing a state of the vehicle body assembly system 1 according to the present embodiment when welding by way of the welding robots 7.

In FIG. 5, the upper jigs 41, 51, 61 of each conveying robot are connected with the lower jig 81 by the fitting holes 414, 514, 614 of the upper-jig connecting parts 413, 513, 613 fitting with the respective robots 814 of the lower-jig connecting parts 813 possessed by the lower jig 81.

Similarly, each component is connected with the lower jig 81 by the positioning pins 812 of the lower jig 81 being guided to insert in the positioning holes.

Each component is thereby precisely positioned relative to the upper jigs 41, 51, 61 and lower jig 81.

As shown in FIG. 5, the vehicle body assembly system 1 according to the present embodiment includes the welding robots 7. More specifically, the vehicle body assembly system 1 includes ten of the welding robots 7 (only two are illustrated for convenience in FIG. 5).

The welding robot 7 includes a spot welder 71, and an arm 72 that causes the position and posture in three-dimensional space of this spot welder 71 to change.

The welding robots 7 of the present embodiment weld together each component as well as welding together parts forming each component, in a state in which the upper jigs 41, 51, 61 and lower jig 81 of each conveying robot are connected, and each component is connected with the lower jig 81, as mentioned above.

The sequence of the vehicle body assembly method by the vehicle body assembly system 1 of the present embodiment including the aforementioned configuration will be explained. The vehicle body assembly method by the vehicle body assembly system 1 of the present embodiment includes a setting step, upper-jig mounting step, connecting step, and welding step.

First, at least one part constituting each component is arranged in the set stand of each component to reproduce the relative position and posture as a component (setting step). However, in the present embodiment as mentioned above, setting on a set stand is unnecessary for the front floor component 20.

Next, at least one part forming each component is gripped and supported by the upper jig, which is a hand of each conveying robot so as to maintain the relative position and posture as a component (upper jig mounting step). At this time, welding together of each part is not performed.

Next, by operation of each conveying robot, the upper jig fixing to mount each part is made to move towards the lower jig, and each rod of the lower-jig connecting parts possessed by the lower jig is made to fit into the fitting holes of the upper-jig connecting parts possessed by the upper jigs (connecting step). At this time, the positioning pins of the lower jig are guided to insert into the positioning holes formed in each part forming the respective components.

Fixing in orientation by the lower jig is thereby possible, and each part forming the respective components is precisely positioned and postured in cooperation with the fixing and gripping by the upper jig. At the same time, the respective components are precisely positioned and postured relative to each other.

Next, while maintaining a state in which the upper jig and lower jig of each conveying robot are connected, and each component is connected with the lower jig, the respective welding robots perform spot welding (welding step). The main floor as a vehicle body structure is thereby assembled.

It should be noted that, in plants, etc. of high production volume, the spots that can be welded without causing the welding robot and upper jig to retract are welded until it is possible to maintain posture as at least the main floor, and then the remaining spots are welded in the next step.

In addition, in plants, etc. of low production volume, after retracting the welding robots, the welding of all spots of the main floor is completed, whereby a subsequent step can be eliminated.

The following effects are exerted according to the present embodiment.

The vehicle body assembly system of the present embodiment includes the upper jigs that fix to mount at least one part in a state that can maintain the relative position and posture as a component, and the lower jig which is connected with the component fixed to mount to the upper jigs, and is connected with the upper jigs. Then, at least one part forming a component and the components are welded together by the welding robots in a state maintaining the connection of the lower jig with the components and the connection between the upper jigs and lower jig.

According to the vehicle body assembly system of the present embodiment, due to performing the welding of at least one part forming a component in parallel with welding together of components, a step for each component that had been assembled by welding in advance conventionally is unnecessary. Therefore, according to the present embodiment, it is possible to consolidate steps, and thus possible to reduce the equipment space and equipment cost.

In addition, with the vehicle body assembly method of the present embodiment, first, at least one part is fixed to mount to the upper jig in a state that can maintain the relative position and posture as a component. Next, the component thus fixed to mount to the upper jig is connected to the lower jig, and the upper jig and lower jig are connected. Then, at least one part forming a component and the components are welded together while maintaining these connected states.

Similar effects as the above-mentioned invention of a vehicle body assembly system are exerted by the vehicle body assembly method of the present embodiment.

It should be noted that the present invention is not limited to the above-mentioned embodiments, and that modifications and improvements within a scope that can achieve the objects of the present invention are included in the present invention.

The above-mentioned embodiments do not provide a front floor set station; however, in the case of the front floor component being configured from a plurality of parts, a front floor set station may be provided. In addition, so long as being able to grip positioning and posturing each part directly to the upper jig of each conveying robot, the set station itself may be eliminated.

### EXPLANATION OF REFERENCE NUMERALS

1 vehicle body assembly system

7 welding robot (welding device)

10 front component (component)

11 front side frame (part)

12 wheelhouse housing (part)

13 bulkhead (part)

14 dashboard (part)

20 front floor component (component)

21 front floor (part)

30 rear front component (component)

31 rear side frame (part)

32 first cross-member (part)

33 second cross-member (part)

41, 51, 61 upper jig

81 lower jig

412, 512, 612 gripper

413, 513, 613 upper-jig connecting part (connecting part)

812 positioning pin

813 lower-jig connecting part (connecting part)

1. A vehicle body assembly system for assembling a vehicle body structure by forming a component from at least one part constituting a vehicle body, and welding together components, the system comprising:
an upper jig that fixes to mount the at least one part in a state that can maintain a relative position and posture as the component;
a lower jig that is connected to the component fixed to mount to the upper jig; and
a welding device,
wherein the upper jig and the lower jig each include a connecting part to be connected to each other, and
wherein the welding device welds together the at least one part forming the component and welds together the components in a state maintaining a connection between the component and the lower jig, and a connection between the upper jig and the lower jig.

2. A vehicle body assembly method of assembling a vehicle body structure by forming a component from at least one part constituting a vehicle body, and welding together the components, the method comprising the steps of:
fixing to mount the at least one part to an upper jig in a state that can maintain a relative position and posture as the component;
connecting the component fixed to mount to the upper jig in the step of fixing to a lower jig, and connecting the upper jig and the lower jig; and
welding together the at least one part forming the component and welding together the components in a state maintaining a connection between the component and the lower jig, and a connection between the upper jig and the lower jig.
